(19) United States
(12) Patent Application Publication
(10) Pub. No.: US 2003/0213137 A1
(43) Pub. Date: Nov. 20, 2003

(54) Measure-By-The-Yard

(76) Inventors: Donald Ray Aman SR., Hillsboro, OR (US); Nola Virginia Aman SR., Hillsboro, OR (US)

Correspondence Address: DONALO RAY AMAN, SR, 1178 NE Thomas, Hills Boro, OR, 97124, US

(21) Appl. No.: 10/436,924

(22) Filed: May 13, 2003

Related U.S. Application Data
(60) Provisional application No. 60/380,201, filed on May 14, 2002.

(51) Int. Cl. B43L 7/00

(52) U.S. Cl. 33/494

(57) ABSTRACT

As a quilter, when you first look at the new design of the tape measure blade, you will see instantly the advantage of having the measurements in inches and yards. The ability to “Convert Inches Into Yards at a Glance”, saves the user of the tape measure time in the conversion process, and making the correct measurements, limiting any errors in measuring their fabric.

We are making a claim of a prior Provisional Patent Application, Reference: Date, May 14, 2002, Application No. 60/380,201 “Measure-By-The-Yard”™

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING Compact Disk Appendix 0005 “Not Applicable”

### BACKGROUND OF THE INVENTION

In the fabric industry, measuring fabric by the yard is very important, especially in the area of quilt making. Quilters need a measuring tool that will help them measure yardage accurately.

A standard (or generic) type of tape measure does not meet the need to measure yardage, it only measures in inches and feet, leaving the quilter to figure the yardage.

Time after time we have discovered the need to measure fabric by the yard. “Measure-By-The-Yard”™ meets this need

### BRIEF SUMMARY OF THE INVENTION

Our purpose of this invention is to improve the blade design of a tape measure, by converting inches into yards. Improving the blade design will give true yardage measurements needed by quilters, without guessing or making the wrong measurements. Also, the quilter, in this case, will not have to use a calculator to figure yardage. The steel blade will lay flat, unlike a plastic or cloth type tape measure, and will not stretch out of true measurements.

The need for this type of tape measure with inches and yards on the blade is a time saver for the quilter, because “Measure-By-The-Yard”™ “Converts Inches Into Yards at a Glance”.

### BRIEF DESCRIPTION OF THE SEVERAL VIEWS OF THE DRAWING

“Not Applicable”

### DETAILED DESCRIPTION OF THE INVENTION

The tape measure being used is in a plastic case, with a steel blade, a thumb locking mechanism, (to lock the blade in place) and a self retractable blade when the thumb lock is released. The tape measure housing is generic in design and will be supplied by the manufacturer (which is not patentable).

In invention is to improve the blade design only, of a measuring tape.

The steel blade is ¾ inch wide, and 12 feet long, (but there will not be any feet measurements on the blade; the 12 feet converts into 144 inches and 4 yards, which is printed on the blade).

The ¾ inch wide blade will be divided in half with a horizonal black line, running the full length of the blade.

The top half of the blade will be marked in inches only, 1 inch to 144 inches, with a black vertical line from the top edge of the blade to the middle line of the blade, marked for each inch for the length of the blade.

Increments of ⅛th. inch markings will be marked between the inch markings on the blade, with a black vertical line, showing where ⅛″, ¼″, ⅜″, ½″, ⅝″, ¾″, ⅞″, will be. (these fractions will not be printed on the blade, only the black vertical lines will be printed)

The bottom half of the blade will be marked in yardage only, with a black vertical line from the bottom edge of the blade up to the middle line of the blade. These yardage measurements on the bottom half of the blade will correspond with the inch measurements on the top half of the blade.

The following is a list of the yardage measurements and the corresponding inch measurements that wil be on the blade. Inches on the top half and yardage on the bottom half divided by the center line.

| yardage | | inches | yardage | | inches |
|---|---|---|---|---|---|
| 1/16 | yd | 2 ¼″ | 2 1/16 | yds | 74 ¼″ |
| ⅛ | yd | 4 ½″ | 2 ⅛ | yds | 76 ½″ |
| ¼ | yd | 9″ | 2 ¼ | yds | 81″ |
| ⅓ | yd | 12″ | 2 ⅓ | yds | 84″ |
| ⅜ | yd | 13 ½″ | 2 ⅜ | yds | 85 ½″ |
| ½ | yd | 18″ | 2 ½ | yds | 90″ |
| ⅝ | yd | 22 ½″ | 2 ⅝ | yds | 94 ½″ |
| ⅔ | yd | 24″ | 2 ⅔ | yds | 96″ |
| ¾ | yd | 27″ | 2 ¾ | yds | 99″ |
| ⅞ | yd | 31 ¼″ | 2 ⅞/ | yds | 103 ½″ |
| 1 | YD | 36″ | 3 | YDS | 108″ |
| 1 1/16 | yds | 38 ¼″ | 3 1/16 | yds | 110 ¼″ |
| 1 ⅛ | yds | 40 ½″ | 3 ⅛ | yds | 112 ½″ |
| 1 ¼ | yds | 45″ | 3 ¼ | yds | 117″ |
| 1 ⅓ | yds | 48″ | 3 ⅓ | yds | 120″ |
| 1 ⅜ | yds | 49 ½″ | 3 ⅜ | yds | 121 ½″ |
| 1 ½ | yds | 54″ | 3 ½ | yds | 126″ |
| 1 ⅝ | yds | 58 ½″ | 3 ⅝ | yds | 130 ½″ |
| 1 ⅔ | yds | 60″ | 3 ⅔ | yds | 132″ |
| 1 ¾ | yds | 63″ | 3 ¾ | yds | 135″ |
| 1 ⅞ | yds | 67 ½″ | 3 ⅞ | yds | 139 1/2″ |
| 2 | YDS | 72″ | 4 | YDS | 144″ |

1. We, Donald Ray Aman, Sr. and Npla Virginia Aman, claim that the measuring tape blade design that we invented makes the process of measuring a quilt top, borders, backing and any other fabric easier. This new design converts the measurements of inches into the completed measurements of yards, which is how fabric is purchased, and refered to, in the United States.
We discovered that there was no such measuring device available: every other measuring tape only displays inches and feet, or inches and centimeters. With our invention “Measure-By-The-Yard”™, the blade shows the actual conversion of inches into yards, up to four yards, so the user instantly knows how Much fabric they need to complete the quilting project, in terms of amounts of fabric to purchase and/or to sew.
